(19) United States
(12) Patent Application Publication
(10) Pub. No.: US 2003/0107948 A1
(43) Pub. Date: Jun. 12, 2003

(54) Devices for mixing materials

(76) Inventor: Hans-Joachim Jacob, Ballrechten-Dottingen (DE)

Correspondence Address: Baker & Daniels, Suite 800, 111 East Wayne Street, Fort Wayne, IN, 46802, US

(21) Appl. No.: 10/275,128

(22) PCT Filed: May 11, 2001
(86) PCT No.: PCT/DE01/01812

(30) Foreign Application Priority Data
May 16, 2000 (DE) 100 23 694.4

(51) Int. Cl. B01F 5/16

(52) U.S. Cl. 366/181.4; 366/304

(57) ABSTRACT

The invention relates to a device which is used to mix materials in a mixer unit (7) which comprises a stator (24) and a rotor (17) arranged in a mixing chamber (18); The aim of the invention is to embody the stator (24) in a different manner in the mixing areas of said mixing chamber (18), said mixing areas being separated by means of a separating disk (20) associated with the rotor (17). As a result, different yield and mixing ratios can be obtained in the mixing areas of the mixing chamber (18).

between each two adjacent rows of holes, which is located in the area of an associated partition plate of the rotor.

Both devices pursuant to the invention are based on the general inventive concept of configuring the wall of the stator differently in mixing regions of the mixing chamber separated by the partition plate, in order to be able to set throughput and mixing proportions for a first input of a substance into one mixing region that are different from the corresponding conditions of a mixing region placed on the other side of the particular partition plate. In this case, the device mentioned first can be considered as a limiting case of the device mentioned second, with a single hole extending over the entire perimeter of the wall.

By providing at least one intermediate rail in the device pursuant to the invention mentioned second, relatively large stators in the longitudinal direction can also be used without the risk of breaking strips of material between holes because of the mechanically stabilizing action of the intermediate rail or of each of them.

Multistage mixing processes can also be projected with devices pursuant to the invention by providing multiple partition plates and a corresponding number of substance inlets and substance outlets.

In the device mentioned first, it is advantageous for separating the mixing regions to provide that the edge rail is thinner than the partition plate.

If no mixing action is to occur in the second mixing region, or very little mixing action, in a refinement of the device pursuant to the invention mentioned first, it is suitable to provide a single row of holes, with the holes of this one row being oriented diagonally to the longitudinal direction of the stator.

In another refinement of the device pursuant to the invention mentioned first, at least two rows of holes are provided. This refinement is intended for multistage mixing processes.

In the device pursuant to the invention mentioned second, and in a device pursuant to the invention mentioned first designed for multistage mixing processes, it is desirable for the widths of the holes in different rows to be different. In a further refinement in this regard, it is desirable for the number of holes in at least two rows to be different to set particularly different mixing proportions in different mixing regions.

In the device pursuant to the invention mentioned second, and in a device pursuant to the invention mentioned first designed for multistage mixing processes, it is desirable, for increased or reduced substance input, to provide that the holes of at least one row are oriented diagonally to the longitudinal direction of the stator. In a further refinement in this regard, it is desirable for holes of at least two rows to be oriented at an angle to one another. In this way, different inputs of substances can be produced into the particular mixing regions.

In the device pursuant to the invention mentioned second, and in a device pursuant to the invention mentioned first designed for multistage mixing processes, for essentially complete separation of the mixing regions on both sides of a partition plate, it is desirable for each of the intermediate rails to be thinner than their associated partition plates.

Other desirable refinements and advantages of the invention are the object of the following description of examples of embodiment with reference to the figures of the drawing. The figures show:

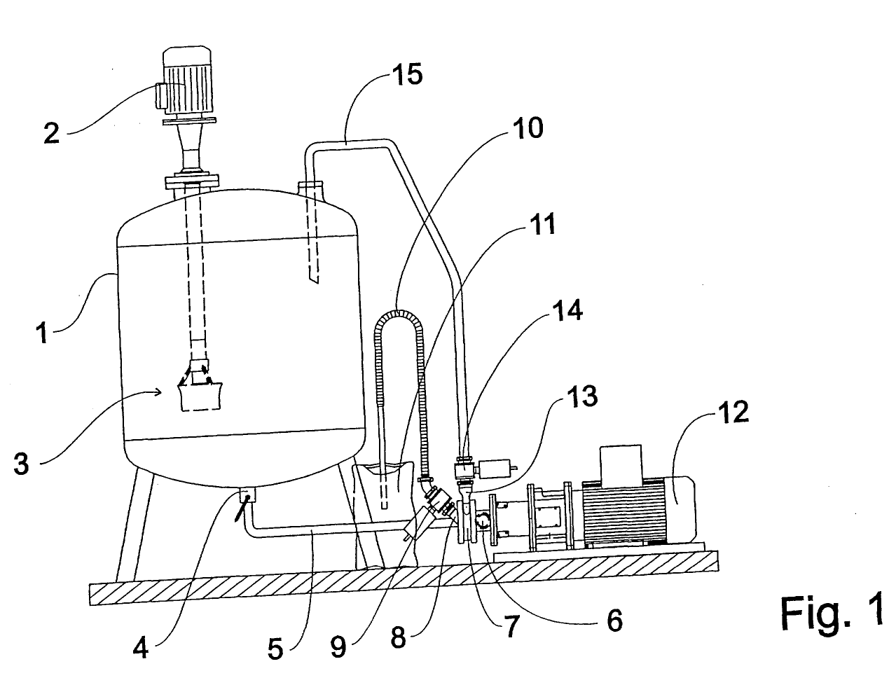

FIG. 1 In side view, a device pursuant to the invention designed as a mixing unit with two substance inlets and one substance outlet, that is operated in a loop,

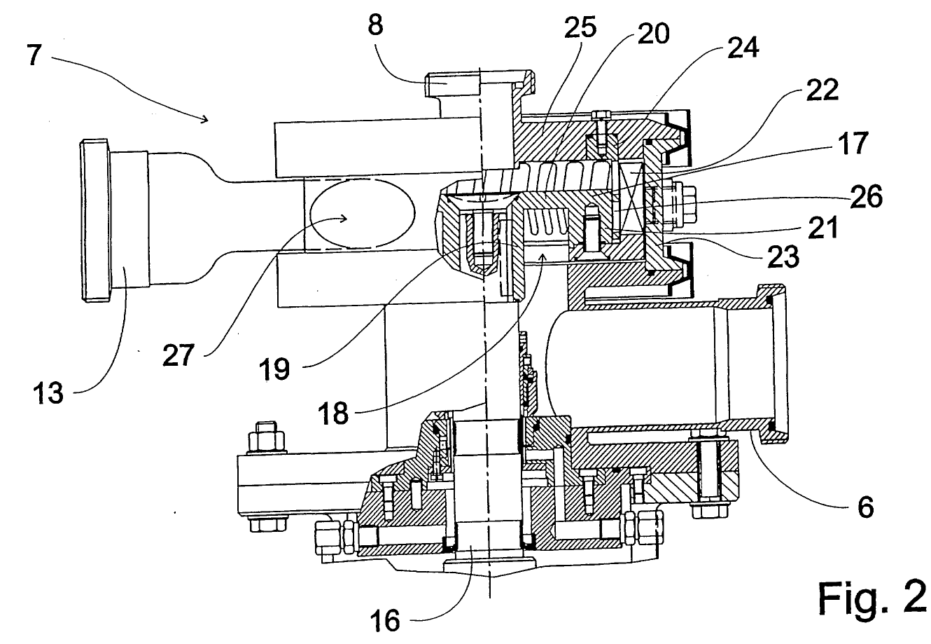

FIG. 2 In a partially cutaway view, a first refinement of a mixing unit with a stator that has two rows of holes,

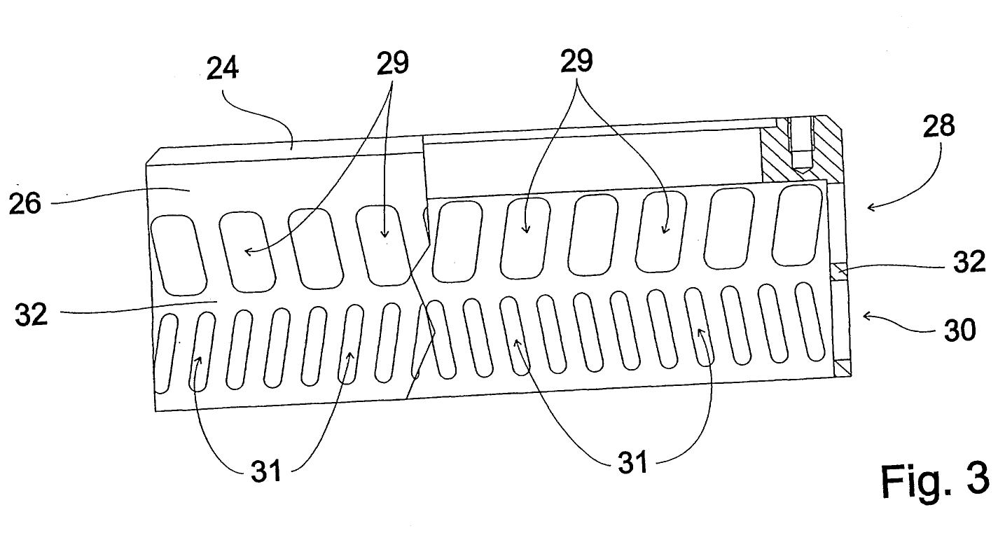

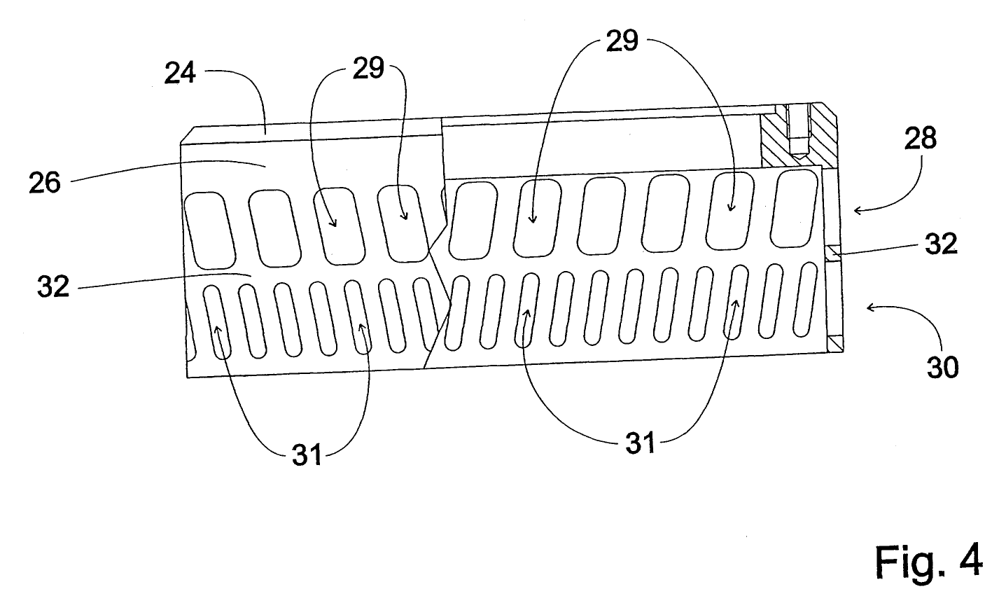

FIGS. 3 and 4 In a partially cutaway side view, refinements of stators for a mixing unit according to FIG. 2,

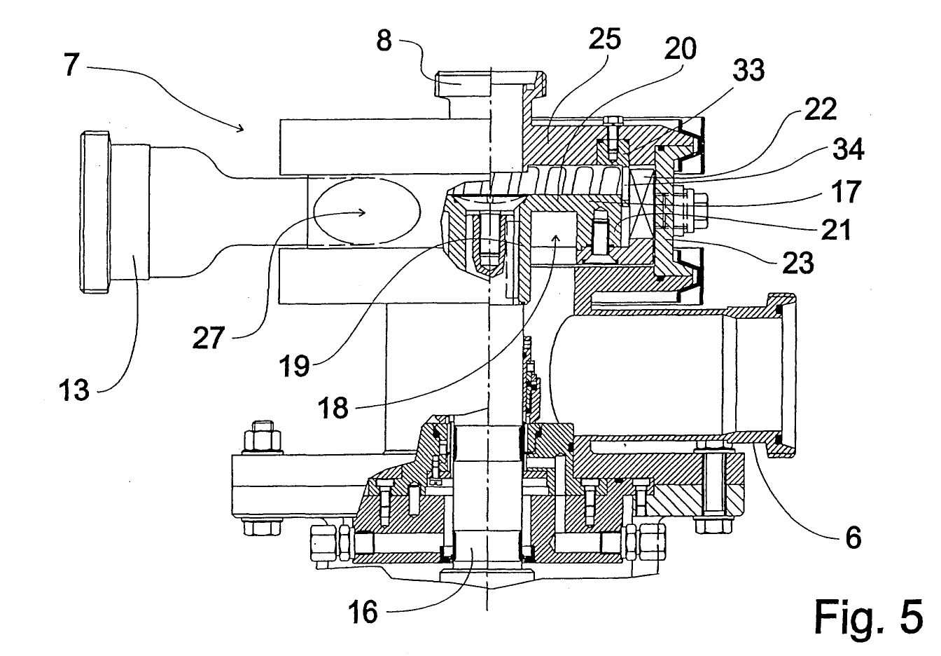

FIG. 5 In a partially cutaway side view, another refinement of a mixing unit with a stator that has only one row of holes that extends over only a portion of the height of a mixing chamber,

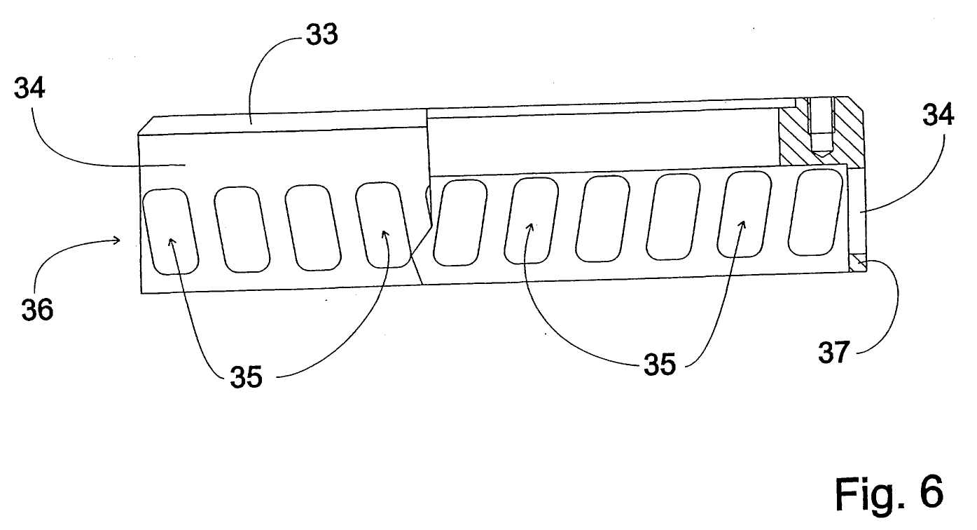

FIG. 6 In a partially cutaway side view, an embodiment of a stator for the mixing unit according to FIG. 5.

FIG. 1 show in side view a tank 1, in which a liquid is stored at the beginning of a mixing process as the first substance of a mixture of substances to be produced. A mixing mechanism 3 driven by a stirrer drive 2 reaches into the tank. The mixing mechanism 3 preferably extends to the lower region of the tank 1 in order to produce effective thorough mixing.

A product infeed valve 4, which is connected also to a first product infeed line 5, is attached at the bottom of the tank 1, which is tapered downward. The first product infeed line 5 opens through a first product inlet connector 6 into a mixing unit 7 as the device pursuant to the invention.

Also attached to the mixing unit 7 is a second product inlet connector 8, onto which is flanged a product inlet valve 9. The product inlet valve 9 is connected to a second product infeed line 10, which extends in the illustration of FIG. 1 into a bag 11 filled with powder as the second substance.

To carry out the mixing process, the mixing unit 7 is connected to a mixer drive 12.

Finally, the mixing unit 7 has a product outlet connector 13 onto which is flanged a product outlet valve 14. The product outlet valve 14 is also connected to a product delivery line 15 that extends into the tank 1 from the top face.

When carrying out the mixing process for mixing the liquid stored in the tank 1 as the first substance with the powder stored in the bag 11 as the second substance, the liquid and the powder arrive at the mixing unit 7, and are mixed there with one another in a way explained in further detail below, and the resultant product goes back into the tank 1. There, the product that has just left the mixing unit 7 is mixed with the liquid and with the product already mixed, and is again fed to the mixing unit 7, until the mixing process is complete with an end product that is then in the tank 1.

FIG. 2 in a partially cutaway view shows a first embodiment of the mixing unit 7. The mixing unit 7 has a drive shaft 16 that is connected to the mixing drive 12 in FIG. 1, not shown. The drive shaft 16 is solidly connected to a rotor 17 that is located in a mixing chamber 18. The rotor 17 has a partition plate 20 extending outward radially from a plug bushing 19 connected to the drive shaft 16. There are axially oriented inner blades 21 distributed circumferentially on the outer edge of the partition plate 20 that extend only on one side of the partition plate 20 in the embodiment according to FIG. 2. The rotor 17 also has outer blades 22 spaced radially from the inner blades, which extend essentially over the entire height of the mixing chamber 18 and are enclosed by an outer wall 23 of the mixing chamber 18.

The mixing unit 7 is also equipped with a stator designed as a double-row stator 24 that is attached to a cover flange 25 closing off the mixing chamber 18 in the area of the second product inlet connector. The double-row stator 24 is cup-shaped with a circumferential wall 26 that is located between the inner blades 21 and the outer blades 22 of the rotor 17.

The outer wall 23 of the mixing chamber 18 is cut through in an outlet area 27 in which the product outlet connector 13 is set.

FIG. 3 in a partially cutaway side view shows the double-row stator 24 of the mixing unit 7 according to FIG. 2. The double-row stator 24 has a number of first holes 29 introduced into the wall 26 arranged circumferentially like trapezoids in a first row 28 with uniform spacing and with rounded corner areas. The double-row stator 24 is also made with a second row 30 of second holes 31 that are likewise introduced into the wall 26 with uniform spacing and with rounded corner areas. The second holes 31 of the second row 30 are not as wide circumferentially as the first holes 29 of the first row 28. The number of holes 31 in the second row 31 [sic] is also greater than the number of holes 29 in the first row 28.

In the embodiment of the double-row stator 24 according to FIG. 3, the holes 29, 31 are aligned at an angle to the longitudinal axis of the double-row stator 24, with the holes 29, 31 likewise being arranged at an angle to one another.

An intermediate rail 32 that is continuous circumferentially is produced between the holes 29, 31 of the two rows 28, 30. The thickness of the intermediate rail 32 in the axial direction of the double-row stator 24 is smaller than the thickness of the partition plate 20 in the axial direction of the rotor 17.

The mixing process with a mixing unit 7 according to FIG. 2 and FIG. 3 takes place as follows. Liquid or already partially mixed product flows in the first product inlet connector 6 from the tank 1 into the mixing chamber 18. Powder as the second substance, for example, flows through the second product inlet connector 8 into the mixing chamber 18. The mixing chamber 18 is divided into a first mixing region and a second mixing region by the partition plate 20, with one row 28, 30 of holes 29, 31 of different dimensions in each case acting in each mixing region. Since the design of the partition plate 20 is thicker than the intermediate rail 32 and the wall 26 of the stator is immersed between the inner blades 21 and the outer blades 22 of the rotor 17, it is guaranteed that substance exchange between the mixing regions is prevented.

In the mixing unit 7 according to FIG. 2 with the double-row stator 24 according to FIG. 3, thorough mixing that is already relatively good occurs in the first mixing region because of the relatively large dimensions of the first holes 29, combined with a relatively high throughput of the entering second substance. Because of the narrower dimensions of the second holes 31 of the second row 30 compared to the dimensions of the first holes 29 of the first row 28, substantially more intensive mixing of the product already partially mixed even just after beginning the mixing process occurs in the second mixing region compared to the first mixing region, still with a sufficiently high throughput. The arrow-like orientation of the holes 29, 31 also increases the transport action in both mixing regions compared to an orientation parallel to the longitudinal direction of the double-row stator 24.

FIG. 4 shows a modification of the double-row stator 24 according to FIG. 3 in which the second holes 31 of the second row 30 are oriented parallel to the first holes 29 of the first row 28, and the holes 29, 31 in each case are diagonal to the longitudinal axis of the double-row stator 24. In this modification, relatively intensive transport, especially of powder as the second substance, into the first mixing region is retained, while because of the orientation of the second holes 31 of the second row 30 modified from the direction of rotation of the rotor 17, compared to the design according to FIG. 3, more intensive mixing is produced in the second mixing region with somewhat reduced throughput.

It is to be understood that other variants with regard to the orientation and dimensions of the holes 29, 31 of the rows 28, 30 can be provided for, depending on the particular throughputs and mixing intensities to be produced in the mixing regions in each case. For example if the second substance infed through the second product inlet connector 8 have to be relatively intensively mixed in even in the first infeed, but then must be subjected only to relatively low mixing forces, the holes in the first mixing region are of relatively small dimensions and in relatively large number, and the holes in the second mixing region are less numerous and of relatively large dimensions.

FIG. 5 shows a mixing unit 7 that is designed according to the mixing unit 7 described with reference to FIG. 2, except for the stator. In this case, identical elements are given the same reference symbols and are not described below in further detail. The mixing unit 7 according to FIG. 5 is made with a single-row stator 33 as the stator, whose wall 34 extends only to the area of the partition plate 20 of the rotor 17 and thus only over the first mixing region of the mixing chamber 18, so that the gap between the inner blades 21 and the outer blades 22 of the rotor 17 is open in the second mixing region.

FIG. 6 shows a side view of the single-row stator 33 according to FIG. 5. Holes 35 are introduced into the wall 34 of the single-row stator 33 that are arranged in only one row 36 and are arranged diagonally to the longitudinal direction corresponding to the holes 29, 31 of the double-row stators 24 explained with reference to FIG. 3 and FIG. 4. The holes 35 end in a border rail 37 at their end pointing toward the center of the mixing chamber 18 that is thinner than the partition plate 20, corresponding to the intermediate rail 32 of the double-row stators 24.

The mixing process using a single-row stator 33 corresponds basically to the mixing process with a double-row stator 24 described with reference to FIG. 2 and FIG. 3, so that the single-row stator 33 can be considered as the theoretical limiting case of a double-row stator 24 with a single hole in the second row extending over the entire circumference. When using a single-row stator 33, the mixing process in the second mixing region is determined solely by the interaction of the inner blades 21 and the outer blades 22 of the rotor 17, with no mixing, or only extremely little mixing, occurring because of this, for example in the case of products very sensitive to shear, such as microballoons, hollow beads, or thickening polymers.

On Point V

Substantiated Statement According to ARTICLE 35(2) with Regard to Novelty, Inventive Act, and Commercial Feasibility: Documentation and Declarations to Support this Statement

1. Reference is made to the following documents:

D1: U.S. Pat. No. 5,540,499 (SEEGER HANSPETER)

D2: DE-B-10 40 513 (WILHELM SCHMITZ)

2. The preamble of claims 1 and 5 refers to an arranged rotor with a (single) partition plate in the device for mixing, but the characterizing part of these claims refers to “ . . . the or each partition plate . . . ”. The result of this is that the definition of the object of these claims is not clear (Article 6 PCT).

It is suggested that an expression such as “ . . . with a rotor that has one or multiple partition plate(s) . . . ” (see p. 3, lines 4-7 of the original version) be used in the preamble of claims 1 and 5, in order to clear this objection.

3.1 Document D1, which is considered the closest state of the art, discloses (see Column 3, Line 58-Column 5, Line 13; and FIGS. 4 and 6) a device for mixing, with a rotor that has a partition plate (67), inner blades (89b), and outer blades (89a) and with a cup-like stator (10) whose wall is penetrated by holes up to the edge rail (10, FIG. 6) that closes off the stator and is located between the inner blades and outer blades of the rotor, with the rotor and the stator being located in a mixing chamber into which a first product inlet connector (74) opens on one side of a partition plate, and a second product inlet connector (81) and a product outlet connector (95) associated with the partition plate open into the other side of the partition plate in question,

from which the object of claim 1 differs in the fact that the edge rail is in the plane of a partition plate and that the or each partition plate divides the mixing chamber into separate mixing regions, with material exchange between the mixing regions in the mixing chamber being prevented.

For this reason the object of claim 1 is new and claim 1 meets the criterion of Article 33(2) PCT.

The task to be accomplished by the present invention is to provide a subdivision of the mixing chamber into two mixing regions, preventing substance interchange, see p. 8, Lines 15-24.

The feature of separating the mixing chamber into two mixing regions by the combination of a partition plate and an edge rail closing off the stator that is positioned in the plane of the partition plate, is not known from the state of the art.

Therefore the method pursuant to the characterizing part of claim 1 is not obvious to one skilled in the art. Thus claim 1 also meets the criterion of Article 33(3) PCT.

3.2 Document D1, which is considered the closest state of the art, discloses (see Point 2.1) a device for mixing, with a rotor that has a partition plate (67), inner blades (89b), and outer blades (89a) and with a cup-like stator (10) whose wall is penetrated by holes up to the edge rail (10, FIG. 6) that closes off the stator and is located between the inner blades and outer blades of the rotor, with the rotor and the stator being located in a mixing chamber into which a first product inlet connector (74) opens on one side of a partition plate, and a second product inlet connector (81) and a product outlet connector (95) associated with the partition plate open into the other side of the partition plate in question,

from which the object of claim 5 differs in the fact at least two rows of holes are introduced into the wall of the stator in the circumferential direction, and in which the dimensions of the holes of one row are different from the dimensions of the holes of at least one other row, and a circumferentially continuous intermediate rail is produced between each two adjacent rows of holes, which is located in the plane of an associated partition plate of the rotor, and the or each partition plate divides the mixing chamber into separate mixing regions, with substance interchange between the mixing regions in the mixing chamber being prevented.

Therefore, the object of claim 5 is new and claim 5 meets the criterion of Article 33(2) PCT.

The task to be accomplished by the present invention is to provide a subdivision of the mixing chamber into two mixing regions, preventing substance interchange, see p. 8, Lines 15-24.

The feature of separating the mixing chamber into two mixing regions by the combination of a partition plate and an edge rail closing off the stator that is positioned in the plane of the partition plate, is not known from the state of the art.

Therefore the method pursuant to the characterizing part of claim 5 is not obvious to one skilled in the art. Thus claim 5 also meets the criterion of Article 33(3) PCT.

3.3 claims 2, 3, 4, 6, 7, 8, 9, and 10 are dependent on claims 1 and 5 and thus likewise meet the requirements of the PCT relative to novelty and inventive act.

5. Because the independent claims of device category 1 and 5 both contain the features of a rail positioned in the plane of a partition plate and separation of the mixing chamber into two mixing regions differentiating from D1, and the same task underlies these claims, the requirements of Rules 13.1 and 13.2 PCT and of Article 6 PCT appear to have been satisfied.

This invention relates to devices for mixing substances, especially for dispersing, suspending, and emulsifying gases and/or liquids and/or free-flowing solid substances, with a rotor that has a partition plate, inner blades, and outer blades, and with a cup-shaped stator whose wall is penetrated by holes, and that is positioned between the inner blades and the outer blades of the rotor, with the rotor and the stator being located in a mixing chamber in which a first product inlet opens at one side of a partition plate, and with a second product inlet and a product outlet associated with the partition plate opening at the other side of the partition plate in question.

A device of the type mentioned initially is disclosed by U.S. Pat. No. 5,540,499. The previously known device has a stator that is located in a mixing chamber into which the substances to be mixed can be introduced through product inlet connectors. Rounded holes of identical dimensions are introduced into the wall of the stator up to an edge rail that closes off the stator. There is also a rotating rotor made with a partition plate and inner blades and outer blades, with the partition plate being located inside the rotor. Substances fed into the mixing chamber are mixed intensively with one another by the interaction of stator and rotor. Although such a device also commonly called an in-line disperser, will already provide relatively good mixing results, mixing with higher throughput and the most flexible possible matching to the particular necessary mixture ratios is desired.

DE-B-10 40 513 discloses a device for mixing substances that is designed as an immersion apparatus or a so-called batch disperser and that has a cylindrical stator with two rows of slotted stator holes introduced into the wall of the stator in the circumferential direction oriented at an angle in the radial direction. An intermediate rail is produced between the rows of stator holes. The dimensions of the stator holes of one row are different from the dimensions of the stator holes of the other row.

The last-mentioned device also has a cylindrical rotor that is mounted to rotate inside the stator, with the inner wall of the stator and the outer wall of the rotor being spaced at a very small distance from one another. The wall of the rotor is likewise provided with two rows of slotted rotor holes oriented radially, but with the dimensions of the rotor holes being the same in each row. There is a partition plate between the rows of rotor holes that is made to connect two mixing regions on the two sides of the partition plate with a number of axially oriented connecting holes.

The last-mentioned device, however, has the drawback that because of the double task produced by the configuration of the immersion apparatus, namely having to circulate the contents of the tank in which it is immersed in addition to mixing the substances themselves, the mixing is unsatisfactory despite the connecting holes provided for better circulation, especially with relatively large tanks, so that the type of apparatus has not become popular for mixing large quantities of substances.

U.S. Pat. No. 6,000,840 also discloses a device designed as an immersion apparatus for mixing substances with a cylindrical stator that has two rows of elongated holes made in the wall. The holes in the rows are spaced radially from one another and are oriented to run in succession at an angle to a central plane of the stator. The rotor, mounted to rotate inside the stator, has V-shaped inner blades extending over the entire inside diameter and height of the stator, with the arms of the inner blades each being oriented perpendicular to the longitudinal direction of the holes. This does produce relatively good dispersing action, but the aforementioned drawbacks typical of immersion apparatus also exist.

The task underlying the invention is to describe devices of the type mentioned initially with which very diverse throughputs and mixture ratios can be set, with relatively high throughput and with relatively little changeover work.

This task is accomplished with a device of the type mentioned initially according to a first type pursuant to the invention, by providing that the edge rail is in the plane of a partition plate and that the (or each) partition plate divides the mixing chamber into separate mixing regions, with substance exchange between the mixing regions in the mixing chamber being prevented.

This task is achieved pursuant to the invention with a device of the type mentioned initially according to a second type, by providing that at least two rows of holes are introduced into the wall of the stator in the circumferential direction, with the dimensions of the holes of one row being different from the dimensions of the holes of at least one other row, and that a circumferentially continuous intermediate rail is produced between each two adjacent rows of holes that is positioned in the plane of an associated partition plate of the rotor, and that the (or each) partition plate divides the mixing chamber into separate mixing regions, with substance exchange between the mixing regions in the mixing chamber being prevented.

The single general inventive concept underlying both devices pursuant to the invention is to configure the wall of the stator into different mixing regions of the mixing chamber by the partition plates, in order to be able to set throughput and mixture ratios in a first infeed of a substance into one mixing region that are different from the corresponding conditions of a mixing region positioned at the other side of the particular partition plate. In this case, the device of the first type can be considered as the limiting case of the device of the second type with a single hole extending over the entire perimeter of the wall.

By providing at least one intermediate rail in a device of the second type pursuant to the invention, relatively large stators in the longitudinal direction can also be used without the risk of breaking strips of material between holes because of the mechanically stabilizing action of the intermediate rail or of each of them.

By providing multiple partition plates and a corresponding number of substance inlets and substance outlets, multistage mixing processes can also be projected with devices pursuant to the invention.

In a device of the first type, it is advantageous for separating the mixing regions to provide that the edge rail is thinner than the partition plate.

If no mixing action is to occur in the second mixing region, or very little mixing action in any event, in a refinement of the device of the first type, it is suitable to provide a single row of holes, with the holes of this one row being oriented diagonally to the longitudinal direction of the stator.

In another refinement of the device of the first type pursuant to the invention, at least two rows of holes are provided. This refinement is intended for multistage mixing processes.

In a device of the second type pursuant to the invention, and in a device of the first type pursuant to the invention designed for multistage mixing processes, it is desirable for the widths of the holes in different rows to be different. In a further refinement in this regard, it is desirable for the number of holes in at least two rows to be different to set particularly different mixing proportions in different mixing regions.

In a device of the second type pursuant to the invention, and in a device of the first type pursuant to the invention designed for multistage mixing processes, it is desirable, for increased or reduced substance input, to provide that the holes of at least one row are oriented diagonally to the longitudinal direction of the stator. In a further refinement in this regard, it is desirable for holes of at least two rows to be oriented at an angle to one another. In this way, different inputs of substances can be produced into the particular mixing regions.

In a device of the second type pursuant to the invention, and in a device of the first type pursuant to the invention designed for multistage mixing processes, for essentially complete separation of the mixing regions on both sides of a partition plate, it is desirable for each of the intermediate rails to be thinner than their associated partition plates.

Other desirable refinements and advantages of the invention are the object of the following description of examples of embodiment with reference to the figures of the drawing. The figures show:

FIG. 1 In a side view, a device pursuant to the invention designed as a mixing unit with two substance inlets and one substance outlet, which is operated in a loop.

FIG. 2 In a partially cutaway view, a first configuration of a mixing of a mixing unit with a stator that has two rows of holes,

1. Device for mixing substances, especially for dispersing, suspending, and emulsifying gases and/or liquids and/or free-flowing solid substances, with a rotor (17) that has a partition plate (20), inner blades (21), and outer blades (22), and with a cup-shaped stator (33) whose wall (34) is penetrated by holes (35) up to an edge rail (37) that closes off the stator (33), and that is positioned between the inner blades (21) and the outer blades (22) of the rotor (17), with the rotor (17) and the stator (33) being located in a mixing chamber (18) in which a first product inlet (6) opens at one side of a partition plate (20), and with a second product inlet (8) and a product outlet (13) associated with the partition plate (20) opening at the other side of the partition plate (20), characterized by the fact that the edge rail (37) is positioned in the plane of a partition plate (20) and that the or each partition plate (20) divides the mixing chamber (18) into separate mixing regions, with exchange of substance between the mixing regions in the mixing chamber (18) being prevented.

2. Device pursuant to claim 1, characterized by the fact that the edge rail (37) is thinner than the partition plate (20).

3. Device pursuant to claim 1 or claim 2, characterized by the fact that there is a single row (36) of holes (35), with the holes (35) in this one row (36) being oriented diagonally to the longitudinal direction of the stator (33).

4. Device pursuant to claim 1 or claim 2, characterized by the fact that there are at least two rows of holes.

5. Device for mixing substances, especially for dispersing, suspending, and emulsifying gases and/or liquids and/or free-flowing solid substances, with a rotor (17) that has a partition plate (20), inner blades (21), and outer blades (22), and with a cup-shaped stator (24) whose wall (26) is penetrated by holes (29, 31) up to an edge rail closing off the stator (24), and that is positioned between the inner blades (21) and the outer blades (22) of the rotor (17), with the rotor (17) and the stator (24) being located in a mixing chamber (18) in which a first product inlet (6) opens at one side of a partition plate (20), and with a second product inlet (8) and a product outlet (13) associated with the partition plate (20) opening at the other side of the partition plate (20) in question, characterized by the fact that at least two rows (28, 30) of holes (29, 31) are introduced into the wall (26) of the stator (24) in the circumferential direction, with the dimensions of the holes (29, 31) of one row (28, 30) being different from the dimensions of the holes (31, 29) of at least one other row (30, 28), and with a circumferentially continuous intermediate rail (32) being produced between each two adjacent rows (28, 30) of holes (29, 31) that is located in the plane of an associated partition plate (20) of the rotor (17), and the or each partition plate (20) divides the mixing chamber (18) into separate mixing regions, with substance exchange between the mixing regions in the mixing chamber (18) being prevented.

6. Device pursuant to claim 4 or claim 5, characterized by the fact that the widths of the holes (29, 31) in different rows (28, 30) are different.

7. Device pursuant to one of the claims 4 to 6, characterized by the fact that the number of holes (29, 31) is different in at least two rows (28, 30).

8. Device pursuant to one of the claims 4 to 7, characterized by the fact that the holes (29, 31) of at least one row (28, 30) are oriented diagonally to the longitudinal direction of the stator (24, 33).

9. Device pursuant to claim 8, characterized by the fact that holes (29, 31) of at least two rows (28, 30) are oriented at an angle to one another.

10. Device pursuant to one of the claims 4 to 9, characterized by the fact that each of the intermediate rails (32) is thinner than its associated partition plate (20).
